(19) United States
(12) Patent Application Publication
(10) Pub. No.: US 2014/0237954 A1
(43) Pub. Date: Aug. 28, 2014

(54) PARTICLE SEPARATOR

(71) Applicant: Rolls-Royce North American Technologies, Inc., Indianapolis, IN (US)

(72) Inventor: Phillip H. Snyder, Avon, IN (US)

(73) Assignee: Rolls-Royce North American Technologies, Inc., Indianapolis, IN (US)

(21) Appl. No.: 14/178,977

(22) Filed: Feb. 12, 2014

Related U.S. Application Data
(60) Provisional application No. 61/769,548, filed on Feb. 26, 2013.

(51) Int. Cl. F02C 7/055

(52) U.S. Cl. CPC F02C 7/055
USPC 55/306

(57) ABSTRACT

One embodiment of the present disclosure is a unique particle separator. Another embodiment is a unique aircraft. Another embodiment is a unique inertial particle separator. Other embodiments include apparatuses, systems, devices, hardware, methods, and combinations for aircraft, engines and particle separators for aircraft and engines. Further embodiments, forms, features, aspects, benefits, and advantages of the present disclosure will become apparent from the description and figures provided herewith.

### CROSS REFERENCE TO RELATED APPLICATIONS

This application claims priority to and the benefit of U.S. Provisional Patent Application No. 61/769,548, filed 26 Feb. 2013, the disclosure of which is now expressly incorporated herein by reference.

### TECHNICAL FIELD

The present disclosure relates to aircraft, engines, and particle separators for aircraft and engines.

### BACKGROUND

Particle separators that effectively remove particles from an airflow to provide relatively clean air to an engine remain an area of interest. Some existing systems have various shortcomings, drawbacks, and disadvantages relative to certain applications. Accordingly, there remains a need for further contributions in this area of technology.

### SUMMARY

One embodiment of the present disclosure is a unique particle separator. Another embodiment is a unique aircraft. Another embodiment is a unique inertial particle separator. Other embodiments include apparatuses, systems, devices, hardware, methods, and combinations for aircraft, engines and particle separators for aircraft and engines. Further embodiments, forms, features, aspects, benefits, and advantages of the present application will become apparent from the description and figures provided herewith.

### BRIEF DESCRIPTION OF THE DRAWINGS

The description herein makes reference to the accompanying drawings wherein like reference numerals refer to like parts throughout the several views, and wherein:

FIG. 1 schematically illustrates some aspects of a non-limiting example of an aircraft in accordance with an embodiment of the present disclosure;

FIG. 2 schematically illustrates a sectional view of some aspects of a non-limiting example of a particle separator in accordance with an embodiment of the present disclosure;

FIG. 3 schematically illustrates an isometric view of some aspects of a non-limiting example of a particle separator in accordance with an embodiment of the present disclosure; and

FIGS. 4A-4C illustrate some particle trajectories for an embodiment of a particle separator in accordance with the present disclosure.

### DETAILED DESCRIPTION

For purposes of promoting an understanding of the principles of the disclosure, reference will now be made to the embodiments illustrated in the drawings, and specific language will be used to describe the same. It will nonetheless be understood that no limitation of the scope of the disclosure is intended by the illustration and description of certain embodiments of the disclosure. In addition, any alterations and/or modifications of the illustrated and/or described embodiment(s) are contemplated as being within the scope of the present disclosure. Further, any other applications of the principles of the disclosure, as illustrated and/or described herein, as would normally occur to one skilled in the art to which the disclosure pertains, are contemplated as being within the scope of the present disclosure.

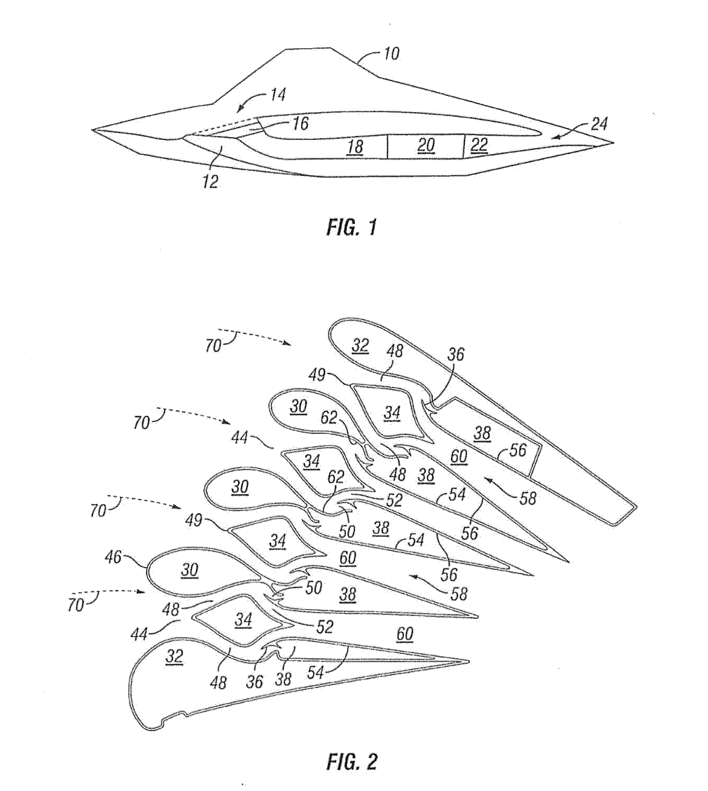

Referring to FIG. 1, some aspects of a non-limiting example of an aircraft 10 in accordance with an embodiment of the present disclosure are schematically depicted. Aircraft 10 includes a flight structure 12, an air inlet 14, a particle separator 16, a transition duct 18, an engine 20, an exhaust nozzle 22, and an exhaust exit 24. In one form, aircraft 10 is a fixed-wing aircraft. In other embodiments, aircraft 10 may be a rotary wing aircraft or any other type of aircraft. In one form, flight structure 12 is a wing structure of aircraft 10. In other embodiments, flight structure 12 may be a fuselage, a lift body, an empennage and/or any other structure of an aircraft. In one form, air inlet 14 and exhaust exit 24 are disposed on an upper surface of flight structure 12. In other embodiments, one or both of air inlet 14 and exhaust exit 24 may be disposed on, embedded in or otherwise attached to or extending from any portion of flight structure 12.

In one form, air inlet 14 is louvered. In other embodiments, air inlet 14 may take any other form. In one form, particle separator 16 is fluidly disposed downstream of air inlet 14. In other embodiments, particle separator 16 may form part or all of air inlet 14. In one form, particle separator 16 is displaced from the inlet of engine 20, and is in fluid communication with the inlet of engine 20 via transition duct 18. In other embodiments, particle separator 1$ may be disposed immediately adjacent to the inlet of engine 20. Particle separator 16 is configured to remove particles within a selected size or mass range from air received via air inlet 14 for use by engine 20, e.g., in providing propulsion or other power for aircraft 10. Transition duct 18 is configured to provide the cleaned air output of particle separator 16 to engine 20. In one form, engine 20 is a gas turbine engine. In other embodiments, engine 20 may be another type of engine. In the form, as a gas turbine engine, engine 20 is a turbofan engine. In other embodiments, engine 20 may be any other type of gas turbine engine, e.g., a turbojet engine, a turboshaft engine, a turboprop engine, a hybrid engine, or may be any other type of turbomachine engine, including, for example, a pulse-jet, pulse detonation, ramjet, scramjet or any other type of subsonic, sonic, supersonic or hypersonic engine.

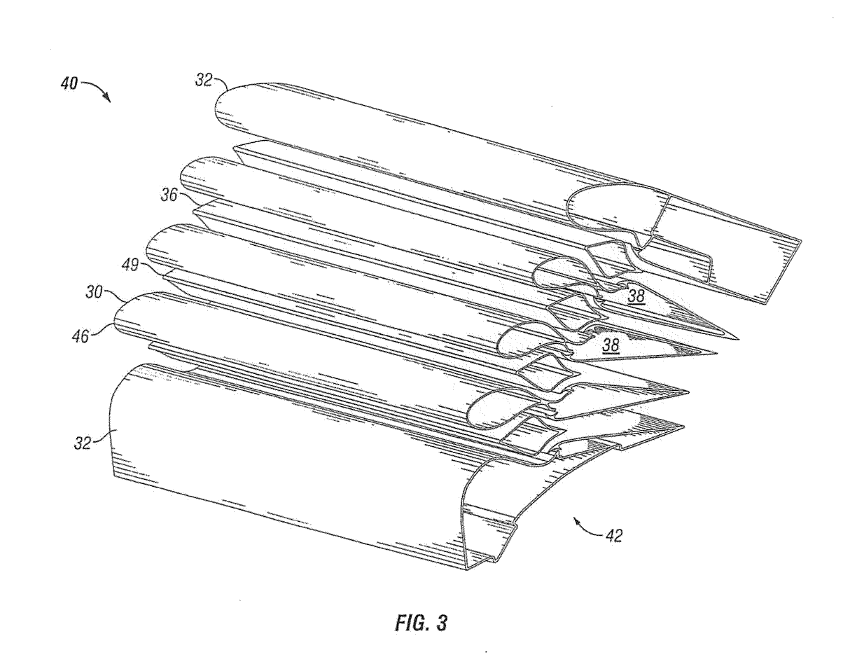

Referring to FIGS. 2 and 3, some aspects of a non-limiting example of particle separator 16 are illustrated in accordance with an embodiment of the present disclosure. Particle separator 16 is an inertial particle separator. In one form, particle separator 16 includes a plurality of linear flow splitters 30, structures in the form of linear end-wall flow guides 32, a plurality of shaped linear flow splitters 34, a plurality of linear flow splitters 36, and a plurality of linear scavenge flowpaths or passages 38. Flow splitters 30, 34 and 36; flow guides 32 and scavenge flowpaths 38 are referred to as “linear” because they are not bodies of revolution disposed about a centerline, but rather, extend generally linearly between side or end 40 and side or end 42. In one form, flow splitters 30, 34 and 36; flow guides 32; and scavenge flowpaths 38 extend in a straight line between ends 40 and 42, e.g., as would an extruded shape. In other embodiments, flow splitters 30, 34 and 36; flow guides 32; and scavenge flowpaths 38 may not extend in a straight line, and may, for example and without limitation, undulate between ends 40 and 42 or otherwise vary from a straight line between ends 40 and 42. In one form, each of flow splitters 30, 34 and 36; flow guides 32; and scavenge flowpaths 38 are formed of sheet aluminum. In other embodiments, other materials may be employed. In the depicted embodiment, a sheet thickness of 0.055 inches is employed. In other embodiments, the material thickness may vary with the needs of the application.

Each flow splitter 30 is disposed adjacent to another flow splitter 30 or to one of flow guides 32. Formed between adjacent flow splitters and/or flow guides 32 are flowpaths 44. In some embodiments, only a single flow splitter 30 may be employed, e.g., disposed between flow guides 32, and form two flowpaths 44. Other embodiments may not employ any flow splitters 30, and may form a single flowpath 44 between flow guides 32. Still other embodiments may employ any number of flow splitters 30, forming (in conjunction with flow guides 32) any number of flowpaths 44.

In one form, flow splitters 34 are disposed downstream of flow splitters 30 and flow guides 32, i.e., downstream of the leading edge portions 46 of flow splitters 30 and flow guides 32. In other embodiments, flow splitters 34 may not be positioned downstream of flow splitters 30 and flow guides 32. Flow splitters 34 are configured to subdivide each flowpath 44 into two flowpaths 48. In one form, each flowpath 48 has the same flow area. In other embodiments, the flow area may vary between instances of flowpaths 48. In one form, flow splitters 36 are disposed downstream of flow splitters 34, i.e., downstream of the leading edge portions 49 of flow splitters 34. In other embodiments, flow splitters 36 may not be disposed downstream of flow splitters 34. Flow splitters 36 are configured to subdivide each flowpath 48 into two flowpaths, a vitiated air flowpath 50 and a cleaned air flowpath 52. Each vitiated air flowpath 50 culminates in a scavenge flowpath 38. In one form, scavenge flowpaths 38 are perpendicular to vitiated air flowpath 50, e.g., perpendicular to the plane of the drawing of FIG. 2. In other embodiments, scavenge flowpaths 38 may be arranged at other angles. Scavenge flowpaths 38 are configured to receive particles captured in vitiated air flowpaths 50. In one form, scavenge flowpaths 38 are configured to discharge the particles to a desired location, e.g., overboard aircraft 10, e.g., via exhaust exit 24. In some embodiments, a scavenge blower (not shown), ejector (not shown) or other device or system may be employed to apply a suction to scavenge flowpaths 38, e.g., in order to assist removal of particles captured in vitiated air flowpaths 50. In other embodiments, no suction may be applied to scavenge flowpaths 38.

Flow splitters 34 are configured to impart an outward velocity (outward relative to flow splitters 34) to particles entrained in the air received into flowpaths 48 and to impart momentum to the particles in the air flow and direct at least some of the particles (with air) toward vitiated air flowpath 50. In one form, flow splitters 34 are configured to impart momentum to particles above a predetermined mass and direct the particles above the predetermined mass (with air) into vitiated air flowpath 50, whereas the balance of the air is a cleaned air flow directed into cleaned air flowpath 52 along with some particles having a mass lower than the predetermined mass. The mass of particles (if any) entering cleaned air flowpath 52 is less than the mass of particles entering vitiated air flowpath 50.

Walls 54, 56 forming scavenge flowpaths 38 define a plurality of linear flow mixers 58. Flow mixers 58 are positioned downstream of flow splitters 36. Flow mixers 58 are configured to combine each adjacent pair of clean air flowpaths 52 into a single flowpath 60. Flowpaths 60 are configured to direct the cleaned air toward the inlet of engine 20.

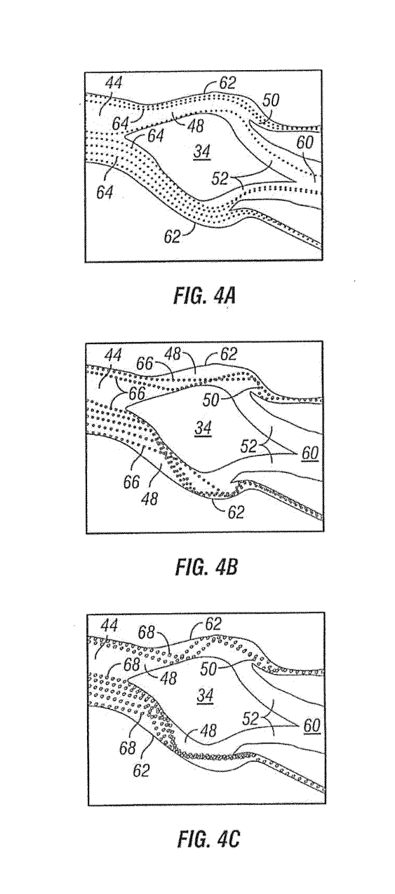

Referring to FIGS. 4A-4C in conjunction with FIGS. 2 and 3, during operation, air flow enters particle separator 16 approximately in the direction indicated by lines 70. The airflow is split and directed into flowpaths 44 by splitters 30 and flow guides 32. The air flow in each flowpath 44 is then split and directed into flowpaths 48 by flow splitters 34. The airflow in each flowpath 48 is then split and directed into vitiated air flowpath 50 and clean air flowpath 52. Adjacent pairs of clean air flowpaths 52 are combined by flow mixers 58 into flowpaths 60. The vitiated air received into vitiated air flowpaths 50 flows into scavenge flowpaths 38 for removal from particle separator 16.

In order to direct most or all of any particles in the air received into particle separator 16 into vitiated air flowpaths 50, flow splitters 34 have a shape configured to impart momentum to particles in the air flowing in flowpaths 48 to direct the particles toward vitiated air flowpaths 50, in addition, the flowpath walls 62 of flowpaths 48, e.g., defined at least in part by flow splitters 30, have a shape configured to direct the particles toward vitiated air flowpaths 50. The path of the particles varies with the size (mass) of the particles. The shapes of flow splitters 34 and flowpaths walls 62 may vary with the needs of the application in order to direct particles within the selected mass range into vitiated air flowpaths 50.

FIG. 4A-4C are analytical results illustrating the calculated trajectories of particles of different masses as they pass through illustrated portions of a non-limiting example of a particle separator 16 in accordance with an embodiment of the present disclosure. FIG. 4A illustrates streams 64 of ultra fine particles passing through the illustrated portions of particle separator 16. FIG. 4B illustrates streams 66 of fine particles passing through the illustrated portions of particle separator 16, wherein the shape of flow splitters 34 and walls 62 are configured to deflect the fine particles impacting flow splitters 34 and walls 62 toward vitiated air flowpath 50. FIG. 4C illustrates streams 68 of course particles passing through the illustrated portions of particle separator 16, wherein the shape of flow splitters 34 and wails 62 are configured to deflect the course particles impacting flow splitters 34 and walls 62 toward vitiated air flowpath 50. The operating conditions for the illustration of FIGS, 4A-4C are an engine 20 take-off power rating at sea level static, standard day inlet conditions. In the non-limiting example illustrated in FIGS. 4A-4C, flow splitters 34 and walls 62 are configured, e.g., in shape and elasticity, to direct substantially all of the fine and course particles into vitiated air flowpath 50, e.g. as illustrated by particle streams 66 and 68, respectively, entering vitiated air flowpath 50; and configured to direct most of the ultra fine particles into vitiated air flowpath 50, e.g. as illustrated by particle streams 64, at the same engine and inlet conditions. Hence, particle separator 16 is configured to provide relatively clean air to engine 20 via flowpaths 52 and 60 in the presence of ultra fine, fine and/or coarse particles in the air received into inlet 14. Other engine power and/or inlet conditions may yield different particle capture results. In the illustrated examples of FIGS. 4A-4C, ultra fine particles are approximately 2 micron; fine particles are approximately 24 micron, and coarse particles are approximately 500 micron. Various embodiments of particle separator 16 may be configured to direct particles of other desired sizes and/or ranges of sizes into desired vitiated air flowpaths 50. Also, in other embodiments, flow splitters 34 and walls 62 may be configured to yield different trajectories for particles of different sizes and/or masses in order to achieve the same or different results, e.g., different degrees of particle capture into vitiated air flowpaths 50 under the same or different engine and inlet conditions.

Embodiments of the present disclosure include a particle separator, comprising: two adjacent first linear flow splitters configured to form a first flowpath therebetween; a second linear flow splitter configured to subdivide the first flowpath into two second flowpaths; and two third linear flow splitters, each third linear flow splitter being configured to subdivide each second flowpath into -a pair of third flowpaths.

In a refinement, the particle separator further comprises a linear flow mixer configured to combine one third flowpath from each of two pairs of third flowpaths into a single fourth flowpath.

In another refinement, the fourth flowpath is configured to direct air toward a gas turbine engine.

In yet another refinement, the second linear flow splitter is positioned downstream of the first linear flow splitters; wherein the third linear flow splitters are positioned downstream of the second linear flow splitter; and wherein the linear flow mixer is positioned downstream of the third linear flow splitters.

In still another refinement, one of the third flowpaths formed by one of the third linear flow splitters is a vitiated air flowpath configured to receive a vitiated air flow wherein the other of the third flowpaths formed by the one of the third linear flow splitters is a clean air flowpath configured to receive a cleaned air flow.

In yet still another refinement, a mass of particles entering the clean air flowpath is less than a mass of particles entering the vitiated air flowpath.

In a further refinement, the second linear flow splitter is configured to impart momentum to particles above a predetermined mass and direct the particles with air toward the vitiated air flowpath.

In a yet further refinement, the balance of the air is directed into the clean air flowpath.

In a still further refinement, each of the second flowpaths have a same flow area.

In a yet still further refinement, the particle separator further comprises a scavenge flowpath in fluid communication with each vitiated air flowpath.

In another refinement, the scavenge flowpath is perpendicular to the vitiated air flowpath.

Embodiments of the present disclosure include an aircraft, comprising: a flight structure; an engine coupled to the flight structure; and a particle separator in fluid communication with the engine, including: one or more structures forming a first flowpath; a first linear flow splitter configured to subdivide the first flowpath into two second flowpaths; and two second linear flow splitters, each second linear flow splitter being configured to subdivide each second flowpath into a pair of third flowpaths.

In a refinement, the particle separator further includes a flow mixer configured to combine one third flowpath from each of two pairs of third flowpaths into a single fourth flowpath.

In another refinement, one of the third flowpaths formed by one of the second linear flow splitters is a vitiated air flowpath configured to receive a vitiated air flow; and wherein the other of the third flowpaths formed by the one of the second linear flow splitters is a clean air flowpath configured to receive a cleaned air flow.

In yet another refinement, a mass of particles entering the clean air flowpath is less than a mass of particles entering the vitiated air flowpath.

In still another refinement, the second linear flow splitter is configured to impart momentum to particles above a predetermined mass and to direct the particles with air toward the vitiated air flowpath.

In yet still another refinement, the balance of the air is directed into the clean air flowpath.

In a further refinement, the particle separator further includes a scavenge flowpath in fluid communication with each vitiated air flowpath. In a yet further refinement, the scavenge flowpath is perpendicular to the vitiated air flowpath.

Embodiments of the present disclosure include an inertial particle separator, comprising: means for forming a first flowpath; means for subdividing the first flowpath into a plurality of second flowpaths; and means for subdividing each second flowpath into a plurality of third flowpaths. In a refinement, the inertial particle separator further comprises means for combining at least some of the third flowpaths into a fourth flowpath.

While the invention has been described in connection with what is presently considered to be the most practical and preferred embodiment, it is to be understood that the disclosure is not to be limited to the disclosed embodiment(s), but on the contrary, is intended to cover various modifications and equivalent arrangements included within the spirit and scope of the appended claims, which scope is to be accorded the broadest interpretation so as to encompass all such modifications and equivalent structures as permitted under the law. Furthermore it should be understood that while the use of the word preferable, preferably, or preferred in the description above indicates that feature so described may be more desirable, it nonetheless may not be necessary and any embodiment lacking the same may be contemplated as within the scope of the disclosure, that scope being defined by the claims that follow. In reading the claims it is intended that when words such as “a,” “an,” “at least one” and “at least a portion” are used, there is no intention to limit the claim to only one item unless specifically stated to the contrary in the claim. Further, when the language “at least a portion” and/or “a portion” is used the item may include a portion and/or the entire item unless specifically stated to the contrary.

What is claimed is:

1. A particle separator comprising:
two adjacent first linear flow splitters configured to form a first flowpath therebetween;
a second linear flow splitter configured to subdivide the first flowpath into two second flowpaths; and
two third linear flow splitters, each third linear flow splitter being configured to subdivide each second flowpath into a pair of third flowpaths.

2. The particle separator of claim 1, further comprising a linear flow mixer configured to combine one third flowpath from each of two pairs of third flowpaths into a single fourth flowpath.

3. The particle separator of claim 2, wherein the fourth flowpath is configured to direct air toward a gas turbine engine.

4. The particle separator of claim 2, wherein the second linear flow splitter is positioned downstream of the first linear flow splitters; wherein the third linear flow splitters are positioned downstream of the second linear flow splitter; and wherein the linear flow mixer is positioned downstream of the third linear flow splitters.

5. The particle separator of claim 1, wherein one of the third flowpaths formed by one of the third linear flow splitters is a vitiated air flowpath configured to receive a vitiated air flow and wherein the other of the third flowpaths formed by the one of the third linear flow splitters is a clean air flowpath configured to receive a cleaned air flow.

6. The particle separator of claim 5, wherein a mass of particles entering the clean air flowpath is less than a mass of particles entering the vitiated air flowpath.

7. The particle separator of claim 5, wherein the second linear flow splitter is configured to impart momentum to particles above a predetermined mass and direct the particles with air toward the vitiated air flowpath.

8. The particle separator of claim 7, wherein the balance of the air is directed into the clean air flowpath.

9. The particle separator of claim 5, wherein each of the second flowpaths have a same flow area.

10. The particle separator of claim 5, further comprising a scavenge flowpath in fluid communication with each vitiated air flowpath.

11. The particle separator of claim 10, wherein the scavenge flowpath is perpendicular to the vitiated air flowpath.

12. An aircraft comprising:
a flight structure;
an engine coupled to the flight structure; and
a particle separator in fluid communication with the engine, the particle separator including:
one or more structures forming a first flowpath;
a first linear flow splitter configured to subdivide the first flowpath into two second flowpaths; and
two second linear flow splitters, each second linear flow splitter being configured to subdivide each second flowpath into a pair of third flowpaths.

13. The aircraft of claim 12, wherein the particle separator further includes a flow mixer configured to combine one third flowpath from each of two pairs of third flowpaths into a single fourth flowpath.

14. The aircraft of claim 12, wherein one of the third flowpaths formed by one of the second linear flow splitters is a vitiated air flowpath configured to receive a vitiated air flow and wherein the other of the third flowpaths formed by the one of the second linear flow splitters is a clean air flowpath configured to receive a cleaned air flow.

15. The aircraft of claim 14, wherein a mass of particles entering the clean air flowpath is less than a mass of particles entering the vitiated air flowpath.

16. The aircraft of claim 14, wherein the second linear flow splitter is configured to impart momentum to particles above a predetermined mass and to direct the particles with air toward the vitiated air flowpath.

17. The aircraft of claim 16, wherein the balance of the air is directed into the clean air flowpath.

18. The aircraft of claim 14, wherein the particle separator further includes a scavenge flowpath in fluid communication with each vitiated air flowpath.

19. The aircraft of claim 18, wherein the scavenge flowpath is perpendicular to the vitiated air flowpath.

20. An inertial particle separator comprising:
means for forming a first flowpath;
means for subdividing the first flowpath into a plurality of second flowpaths; and
means for subdividing each second flowpath into a plurality of third flowpaths.
